(19) United States
(12) Patent Application Publication
(10) Pub. No.: US 2015/0073939 A1
(43) Pub. Date: Mar. 12, 2015

(54) ELECTRONIC COMMERCE CATALOG PRICING

(71) Applicant: Oracle International Corporation, Redwood Shores, CA (US)

(72) Inventors: Kristen J. FLANAGAN, Brighton, MA (US); Kevin MCHUGH, Belfast (GB); Aisling GRANT, Warrenpoint (GB); Paul MACRORY, Ballymena (GB)

(21) Appl. No.: 14/024,056

(22) Filed: Sep. 11, 2013

(51) Int. Cl. G06Q 30/06

(52) U.S. Cl. CPC G06Q 30/0603
USPC 705/26.61

(57) ABSTRACT

A system that prices products of a catalog of an e-commerce web site designates a product as non-discountable. Subsequently, during interaction with the e-commerce web site, the system may receive a request to discount the product as part of a promotion. The system then prevents the discount of the product.

### FIELD

One embodiment is directed generally to a computer system, and in particular to a computer system that provides electronic commerce catalog pricing.

### BACKGROUND INFORMATION

Electronic commerce, or “e-commerce”, is generally considered the buying and selling of a product or service over electronic systems, or a “commerce network”, such as the Internet and other computer networks. Electronic commerce can include functionality such as mobile commerce, electronic funds transfer, supply chain management, Internet marketing, online transaction processing, electronic data interchange (“EDI”), inventory management systems, and automated data collection systems. Electronic commerce and a commerce network as a core function provides the exchange of data to facilitate the financing and payment aspects of business transactions. Further, a commerce network that accommodates many different types of payments accumulates data that can provide useful analytical information.

An e-commerce web site or storefront typically provides a catalog of available items for purchase, prices for the products, and infrastructure for supporting purchases including a shopping cart and payment mechanism. Because prices are represented electronically, they can easily be modified. Some e-commerce retailers frequently modify catalog prices in reaction to changing market conditions and competitive pricing, frequently run price promotions, and are constantly fine-tuning how and where items and offers are presented in order to keep customers engaged.

### SUMMARY

One embodiment is a system that prices products of a catalog of an e-commerce web site. The system designates a product as non-discountable. Subsequently, during interaction with the e-commerce web site, the system may receive a request to discount the product as part of a promotion. The system then prevents the discount of the product.

### BRIEF DESCRIPTION OF THE DRAWINGS

FIG. 1 is a block diagram of a computer system that can implement an embodiment of the present invention.

FIG. 2 illustrates a user interface that allows a user to select an emergency project in accordance to one embodiment.

FIG. 3 is a flow diagram of the functionality of the e-commerce catalog pricing module of FIG. 1 when pricing items in a catalog in accordance with one embodiment.

FIG. 4 illustrates a user interface that allows a user to designate a product or SKU as non-discountable.

FIG. 5 illustrates a user interface in which a warning message is generated when the user selects or hovers over the “peasant skirt” item that is non-discountable.

FIG. 6 is a flow diagram of the functionality of e-commerce catalog pricing module of FIG. 1 when designating a product or SKU as non-discountable in accordance with one embodiment.

### DETAILED DESCRIPTION

One embodiment is an electronic commerce (“e-commerce”) catalog pricing system that provides “emergency project” pricing so that a price of a product can be changed quickly and much of the typical pricing change workflow can be bypassed. Further, the pricing system allows a product to be specified as “non-discountable” to assure that the product is not inadvertently discounted as part of a promotion or other mechanism.

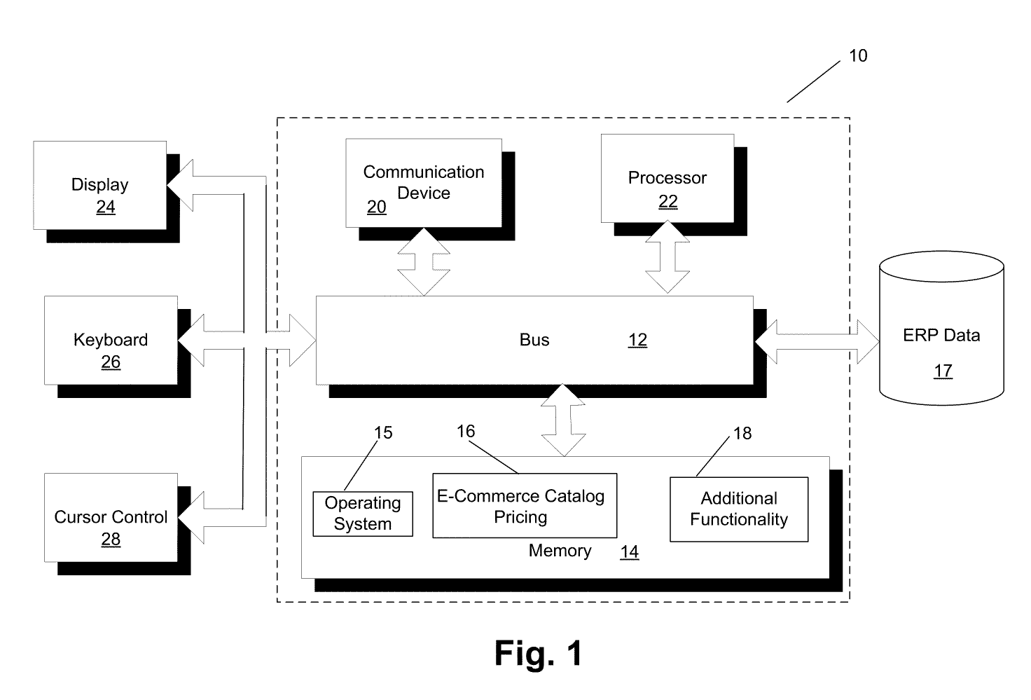

FIG. 1 is a block diagram of a computer system 10 that can implement an embodiment of the present invention. Although shown as a single system, the functionality of system 10 can be implemented as a distributed system. Further, embodiments do not need to include all elements shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method. In one embodiment, the user of system 10 would be a person responsible for setting prices on an e-commerce web site or sites or any other type of content administration (“CA”).

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include an e-commerce catalog pricing module 16 that provides e-commerce catalog pricing, as disclosed in more detail below. System 10 can be part of a larger system, such as “Oracle ATG Web Commerce” from Oracle Corp. or an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing information, inventory information, ERP data, etc.

Price changes to items or assets, housed in “projects”, are typically tightly controlled in an e-commerce environment to prevent costly mistakes or even fraud (projects are the containers that house the set of all changes that should be deployed together). Most e-commerce systems incorporate a multi-step workflow queue before deploying a price change into “production” (i.e., having the price change go live on the e-commerce web site). For example, Oracle ATG Web Commerce 10.1 requires the following steps before deploying a changed price for a project: (1) author the change (by the person making the changes); (2) content review; (3) approval for production deployment received; (4) deploy change; (5) wait for production deployment completion; and (6) verify production deployment. If the user is backing out of the change, a further step is (7) wait for production revert deployment completion. In one embodiment, the “deploy change” step, in the case of the production target, involves deployment to two production data sources. One of the two data sources is “active” on production, and one is inactive. The deployment deploys first to the inactive, then makes it the active, then deploys to the newly inactive. This ensures that the active data source is never being written to during deployments.

However, it is sometimes necessary for users to perform a small but important update to the production data such as a “quick fix”. Examples include a mistake in pricing, a product that is incorrectly described or that needs to be taken off the web site, or a re-sequencing of a popular product on the web site. In this type of situation, a user cannot afford to wait for the normal/standard multiple step deployment process. However, bypassing the typical deployment process and editing the data directly on production is not, of itself, a valid solution. Such an approach would, by design, put the production and publishing data “out of sync”, thereby raising the prospect of unpredictable and possibly catastrophic consequences when future “standard” deployments are executed. Specifically, for a user to make an edit live, the user would have to edit the “active” production data source. However, this should never be done because the website user would be seeing data as it is partially modified, and would be seeing potentially serious errors because the deployment processes that manage the links between data would not have been run. Therefore, in one embodiment, the solution is part of the deployment process, because the deployment processes must be run.

One example of when an “emergency project” is needed includes a simple decimal place error where a product that should retail at $500 is priced at $5.00. The mistake may cause social media networks to start buzzing and cause the product to be bought on an industrial scale to the point where the entire site may crash. Further, each purchase at the mistakenly low price will cause a loss to the seller. Another example is a “buy one get one free” promotion designed to increase sales of candlesticks, kitchen clocks and other products in the $20-$30 price range that has accidentally been assigned to the $14,000 suite of furniture. This may cause sales of the furniture suites to suddenly jumped by 5,000%. In both of these example situations the absolute priority is for the user to fix the site; everything else is secondary.

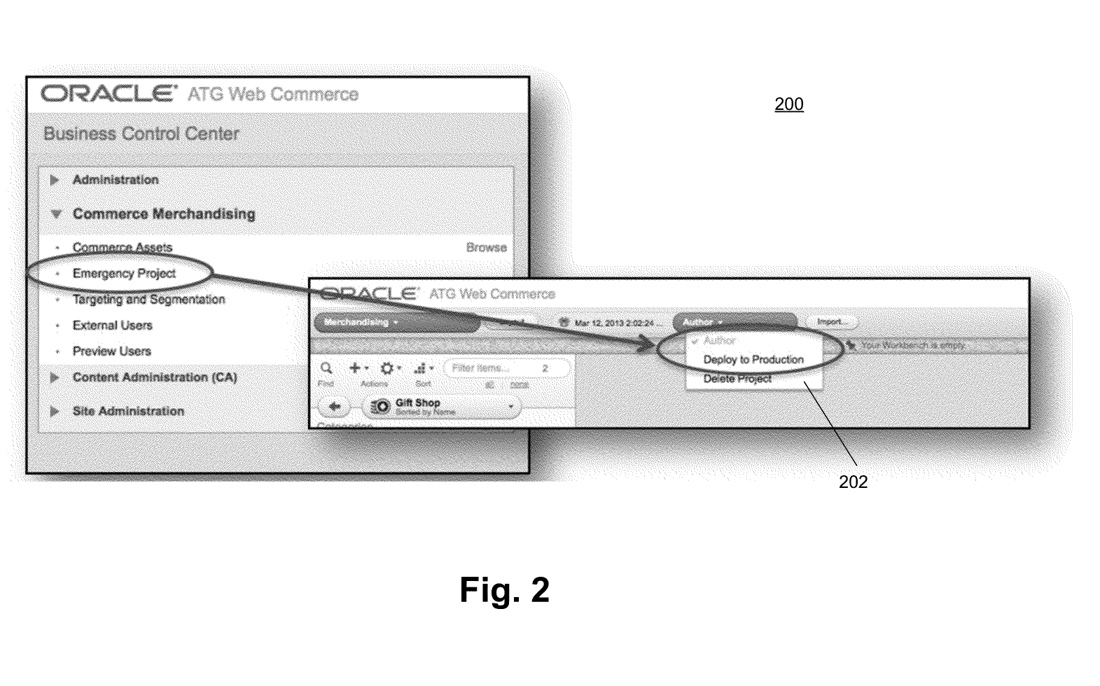

For these types of situations, embodiments incorporate an emergency project that requires only two workflow steps: (1) author; (2) deploy. Thus, this emergency project bypasses four of the workflow steps described above for the typical project. FIG. 2 illustrates a user interface 200 that allows a user to select an emergency project in accordance to one embodiment. As shown in pop-up selection box 202, the choices presented are to author a new project (i.e., create the changed pricing), deploy the project to production, or delete the project. The emergency project moves to the front of the deployment queue ahead of any other projects currently in the queue.

The availability of the emergency project is role-based in one embodiment. For example, an “Emergency Project” role that gives users the Emergency Workflow access right can be added to existing roles. The role can be combined with any existing user role and role based access control functionality.

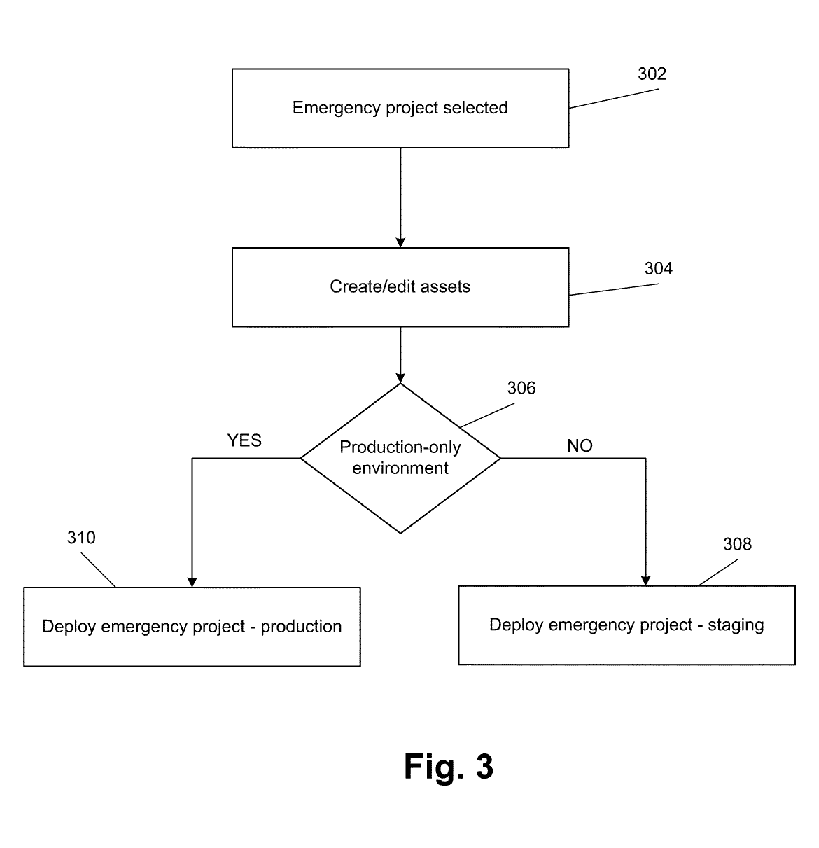

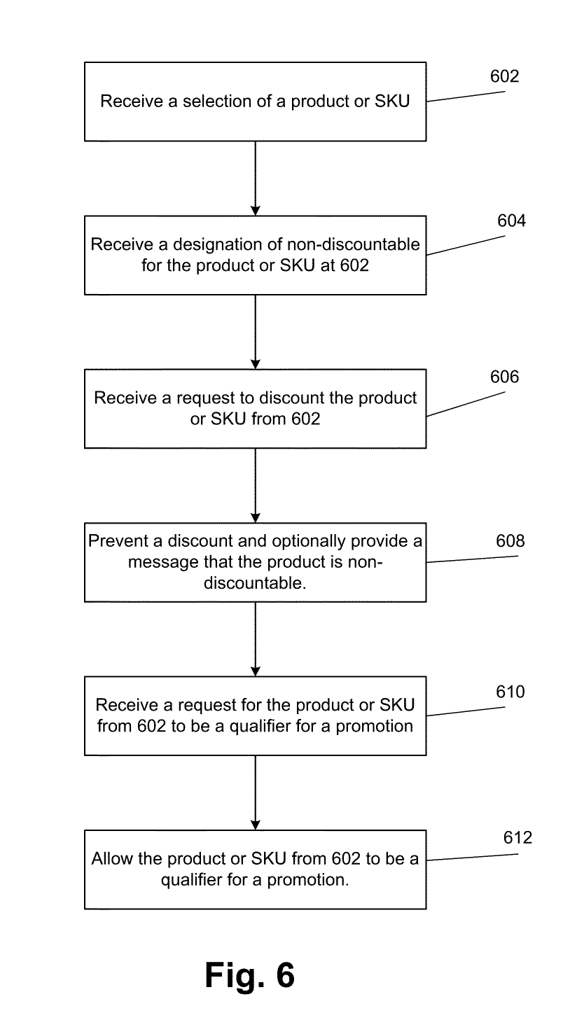

FIG. 3 is a flow diagram of the functionality of e-commerce catalog pricing module 16 of FIG. 1 when pricing items in a catalog in accordance with one embodiment. In one embodiment, the functionality of the flow diagram of FIG. 3, and FIG. 6 below, is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

For the functionality shown in FIG. 3, two workflow deployment environments are contemplated: production or staging. A production environment is the default deployment and supports deployment to a single target. A staging environment supports deployment to two targets: first a staging target and then a production target. In one embodiment, the “production” only environment requires the system to maintain synchronicity between two systems, publishing and production. Further, in a staging/production environment embodiment, the system must maintain synchronicity between three systems, publishing, staging and production.

The project tasks for a “normal” production in a production environment are:
Author;
Content Review;
Approve for Production Deployment;
Wait for Production Deployment Completion;
Verify Production Deployment; and
Wait for Production Revert Deployment Completion.

The project tasks for a “normal” deployment in a staging environment are:
Author;
Content review;
Approve for Staging Deployment;
Wait for Staging Deployment completion;
Verify Staging Deployment;
Approve for Production Deployment;
Wait for Production Deployment completion; and
Verify Production Deployment.

The project tasks for an emergency project in either as production or staging environment are:
Author; and
Deploy to Production.

Referring again to FIG. 3, at 302 the emergency project is started in response to a user selection the emergency project operation.

At 304, assets are created/edited. In one embodiment, any item that a user can create, edit, and deploy is referred to as an “asset.” For example, merchandising assets may include products, SKUs, and price lists. Personalization assets may include user segments, targeters, and content groups.

At 306, it is determined whether the user has selected a deploy to production action.

If no at 306, at 308 the emergency project is deployed to staging (after first being deployed to production).

If yes at 306, at 310 the emergency project is deployed to production.

Although described in the context of pricing, an emergency project in accordance to embodiments of the invention in general is a special workflow that enables users to get mission-critical changes in production and live quickly and is applicable to more than just price changes. It bypasses several of the standard workflow steps for many types of changes. Embodiments can be used by users, for example, to change a name or a category, or the sequence of products, as well as a price.

Further to the desire to make emergency price changes, in connection with discount or promotion pricing, almost every merchant has a set or subset of their products that they generally never want to discount. However, known e-commerce systems do not include a simple/easy way to exclude products from being discounted. Instead, known systems typically require users to define these products as exclusions in every promotion they create.

One embodiment includes the following features:
Products and/or stock keeping units (“SKUs”) can be designated as non-discountable.
Once a product or SKU has been flagged as non-discountable, the merchandising user will get a warning if they try to use the product or SKU in a promotion from within a “Promotions” user interface or other mechanism used to define promotions.
Products or SKUs that are non-discountable should be allowed as qualifiers when evaluating a promotion's condition.
Promotions should never discount a product/SKU that has been flagged as non-discountable.
Gift With Purchase (“GWP”) promotions should either fail or partially fail if the free gift(s) offered are non-discountable.
Merchants should be able to import/export these exclusions as part of their product import/export process. For example, the non-discountable feature may be present in third party catalog management systems and this property of a product must be supported by the import/export process (i.e., if the product is non-discountable in the master/source system this must be reflected when it is imported into another system, and likewise if the system is exporting catalog information to a third party system).

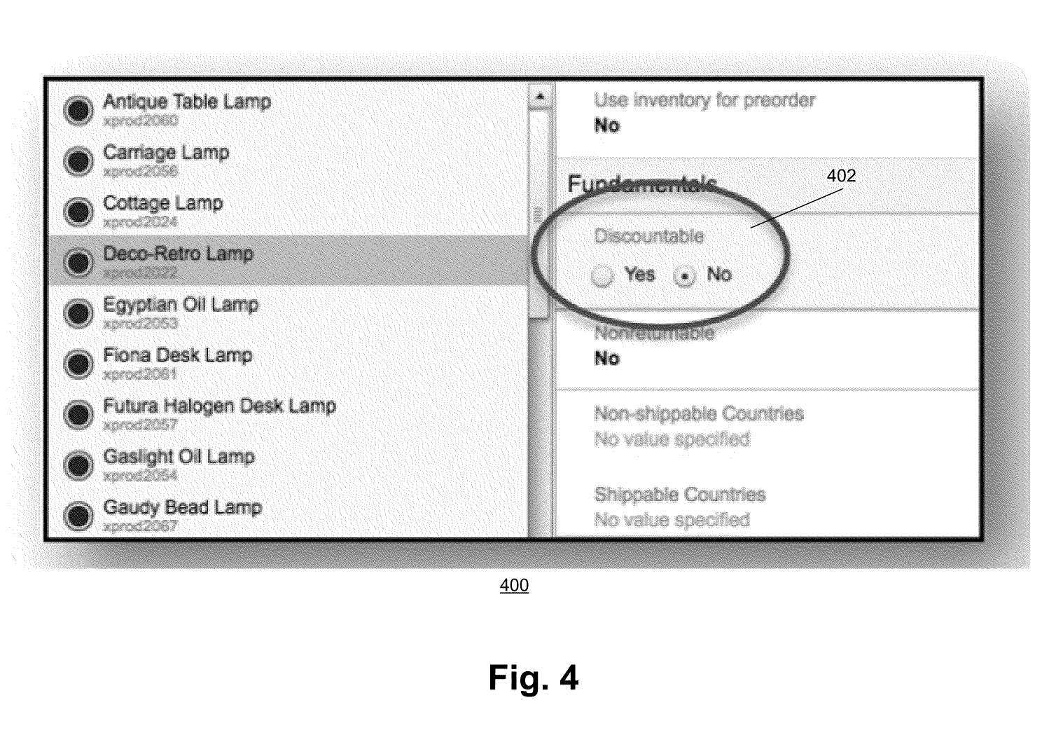

FIG. 4 illustrates a user interface 400 that allows a user to designate a product or SKU as non-discountable. In the example of FIG. 4, the selected product on the left (i.e., the “Deco-Retro Lamp”) is designated as non-discountable by the selection of the radio button at 402. A product may include many SKUs. For example, a men's sock may include a separate SKU based on size/color of each available sock.

In one embodiment, a non-discountable product or SKU can act as a qualifier for a promotion, but cannot be discounted by a promotion. As a result, they can be used in the promotion's condition but not in the offer. For example, a non-discountable product or SKU could not be used in a buy one get one free promotion since at least two of the same items would have to act as both a qualifier and a target. Further, a non-discountable product or SKU could act as a qualifier for a “Buy X Get a Gift” promotion assuming that the free gift was discountable. Further, a non-discountable product or SKU could act as a qualifier for a “Buy Item X Get Item Y” promotion assuming that Y was discountable.

In one embodiment, a product being marked as non-discountable will override any SKU setting. If a product is marked as non-discountable, all SKUs associated with this product will become non-discountable even if the individual SKUs have been marked as discountable. Further, a non-discountable SKU in a discountable product is non-discountable. If a SKU has been marked as non-discountable, the SKU will be treated as non-discountable and a product flag for any discount will be ignored by module 16. For example, if a merchandiser wanted to ensure that all large weekend t-shirts could not be discounted by a promotion, the merchandiser would leave all SKUs with a size other than large as the default discountable. The merchandiser would set all of the large SKUs as non-discountable and leave the product as non-discountable. This would ensure, for example, that only the white, red and black t-shirts in medium could be discounted if those are the only available t-shirts not in large.

In one embodiment, if a user checks out of an e-commerce web site using a shopping cart, and if the cart contains any non-discountable items, then these items will not be included in the order total for discount. If a cart contains only items that are non-discountable, there will be no discount for total order discount promotions.

For example, if there is an order promotion that offers 10% off an order and the cart contains two products:
Product A ($100)—Discountable; and
Product B ($100)—Non-Discountable.
   The expected discount will be $10 rather than $20 as the non-discountable item does not contribute to the overall order discount amount—the 10% is taken off the discountable Product A—which equates to a $10 discount.

As another example, if there was an order promotion “Spend $500 get $100 off your order” and the cart contains the following two products:
Product A ($20)—Discountable; and
Product B ($500)—Non-Discountable.
   The expected discount will be $20 as the non-discounted item does not contribute to the discount amount and the total of the discountable items was $20. The promotion still qualifies as non-discountable item (Product B) can act as a qualifier for the promotion.

As another example, if there was an order promotion “Spend $500 get $100 off your order” and the cart contains the following two products:
Product A ($20)—Non-discountable; and
Product B ($500)—Non-Discountable.
   The expected discount will be $0 as the cart contains only non-discountable items and non-discountable items cannot contribute to the discount amount on the order.

In one embodiment, if an order promotion qualifies but a discount is not applied because every item in the order is non-discountable, a promotion “upsell” should not be evaluated. This is because the promotion will still have qualified, so the merchant would not want a promotion upsell being triggered such as letting the shopper know: “Save $100 on orders over $500” when the order total is currently over $500. An upsell allows the site to inform customers when they are close to qualifying for a promotion. For example, a user can set up an upsell so that when the shopping cart reaches $75, the shopper gets a message of: “$25 more for free shipping”.

In one embodiment, non-discountable items do not affect any available shipping discounts—the shipping discount will apply regardless of whether the cart contains non-discountable items or not. This is because the items in the cart are not being discounted or used as the offer for the promotion—the offer is merely discounted shipping.

For example, if there was a shipping promotion “Spend $100 get free shipping” and the cart contains the following three products:
Product A ($20)—Non-discountable;
Product B ($70)—Non-Discountable; and
Product C ($25)—Non-Discountable.
   The promotion qualifies because the three non-discountable products bring the order total over $100. Free shipping will be applied as the offer for the promotion does not include any of the items in the cart.

In one embodiment, for item discounts, the merchandiser can choose whether to apply the discount to the lowest priced item first or the highest priced item first. For example, if the cart contains any items that are non-discountable, these items need to be removed from the list of items to be evaluated at pricing time and will never receive the discount.

For example, assume there is an item discount promotion: “Spend $100 get 10% of any shoes” and the merchandiser has set the promotion up so that the discount is applied to the lowest priced item first. The cart contents are:
Oxford Brogues ($70)—Discountable;
Peep Toe Pumps ($60)—Non-Discountable; and
Classy Sling back ($60)—Discountable.
   The 10% discount will be applied to the “Classy Sling Back” since it is the lowest priced item and is discountable. The 10% discount will NOT be applied to the “Peep Toe Pumps” as they are non-discountable.

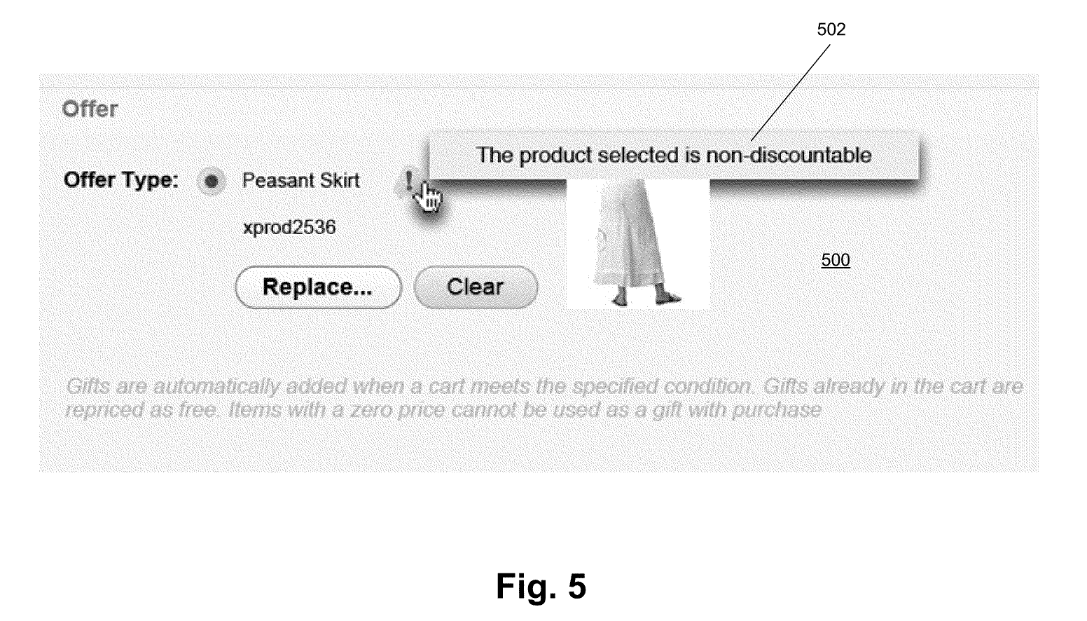

In one embodiment, a message is generated for the user when a non-promotional item is selected. FIG. 5 illustrates a user interface 500 in which a warning message 502 is generated when the user selects or hovers over the “peasant skirt” item that is non-discountable.

FIG. 6 is a flow diagram of the functionality of e-commerce catalog pricing module 16 of FIG. 1 when designating a product or SKU as non-discountable in accordance with one embodiment.

At 602, module 16 receives a selection of a product or SKU.

At 604, module 16 receives a designation of non-discountable for the product or SKU.

At 606, module 16 receives a request to discount the product or SKU from 602.

At 608, module 16 prevents a discount and optionally provides a message that the product is non-discountable.

At 610, module 16 receives a request for the product or SKU from 602 to be a qualifier for a promotion.

At 612, module 16 allows the product or SKU from 602 to be a qualifier for a promotion.

As disclosed, embodiments provide emergency project pricing for a product or SKU in order to quickly implement a price change and bypass the normal workflow. Further, embodiments allow certain products or SKUs to be designated non-promotional in order to override any products for those products or SKUs throughout the e-commerce system.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to price products of a catalog of an e-commerce web site, the pricing comprising:
designating a first product as non-discountable;
during interaction with the e-commerce web site, receiving a request to discount the first product as part of a first promotion; and
preventing the discount of the first product.

2. The computer readable medium of claim 1, wherein the first product comprises a plurality of stock keeping units (SKUs), the pricing further comprising:
during interaction with the e-commerce web site, receiving a request to discount a first SKU of the plurality of SKUs as part of a second promotion; and
preventing the discount of the first SKU.

3. The computer readable medium of claim 1, the pricing further comprising:
during interaction with the e-commerce web site, receiving a request for the first product to be a qualifier for a third promotion; and
allowing the first product to be the qualifier for the third promotion.

4. The computer readable medium of claim 1, the pricing further comprising:
receiving a request for an emergency change of pricing for a second product;
deploying the change of pricing to the e-commerce web site without waiting for approval of a production deployment.

5. The computer readable medium of claim 4, further comprising:
determining a role of a user that provided the request for the emergency change before deploying the change.

6. The computer readable medium of claim 1, the pricing further comprising:
adding a plurality of products to a shopping cart, wherein the first product is one of the plurality of products and the rest of the products are discountable;
applying the discount to an order total that includes all of the plurality of products except the first product.

7. A method of pricing products of a catalog of an e-commerce web site, the method comprising:
designating a first product as non-discountable;
during interaction with the e-commerce web site, receiving a request to discount the first product as part of a first promotion; and
preventing the discount of the first product.

8. The method of claim 7, wherein the first product comprises a plurality of stock keeping units (SKUs), the pricing further comprising:
during interaction with the e-commerce web site, receiving a request to discount a first SKU of the plurality of SKUs as part of a second promotion; and
preventing the discount of the first SKU.

9. The method of claim 7, the pricing further comprising:
during interaction with the e-commerce web site, receiving a request for the first product to be a qualifier for a third promotion; and
allowing the first product to be the qualifier for the third promotion.

10. The method of claim 7, the pricing further comprising:
receiving a request for an emergency change of pricing for a second product;
deploying the change of pricing to the e-commerce web site without waiting for approval of a production deployment.

11. The method of claim 10, further comprising:
determining a role of a user that provided the request for the emergency change before deploying the change.

12. The method of claim 7, further comprising:
adding a plurality of products to a shopping cart, wherein the first product is one of the plurality of products and the rest of the products are discountable;
applying the discount to an order total that includes all of the plurality of products except the first product.

13. A computer readable medium having instructions stored thereon that, when executed by a processor, cause changes to an e-commerce web site, the changes comprising:
creating emergency assets to be changed;
authoring an emergency change for the emergency assets;
deploying the emergency change to production of the web site without waiting for approval of production deployment, wherein the emergency change is at least one of a price change, a product description change, or a resequencing of products change.

14. The computer readable medium of claim 13, wherein the emergency assets to be changed form an emergency project.

15. The computer readable medium of claim 14, further comprising:
creating non-emergency assets to be changed;
authoring a non-emergency change for the non-emergency assets; and
reviewing the content, generating an approval for product deployment and deploying the non-emergency change to production of the web site.

16. The computer readable medium of claim 13, further comprising:
designating a first product as non-discountable;
during interaction with the e-commerce web site, receiving a request to discount the first product as part of a first promotion; and
preventing the discount of the first product.

17. The computer readable medium of claim 16, wherein the first product comprises a plurality of stock keeping units (SKUs), further comprising:
during interaction with the e-commerce web site, receiving a request to discount a first SKU of the plurality of SKUs as part of a second promotion; and
preventing the discount of the first SKU.

18. The computer readable medium of claim 16, further comprising:
adding a plurality of products to a shopping cart, wherein the first product is one of the plurality of products and the rest of the products are discountable;
applying the discount to an order total that includes all of the plurality of products except the first product.
